(19) United States
(12) Patent Application Publication
(10) Pub. No.: US 2024/0359258 A1
(43) Pub. Date: Oct. 31, 2024

(54) METHOD FOR THE LASER BEAM WELDING OF A PLURALITY OF COMPONENT PARTS AT DIFFERENT PROCESSING LOCATIONS, AND LASER WELDING APPARATUS

(71) Applicant: TRUMPF Laser- und Systemtechnik GmbH, Ditzingen (DE)

(72) Inventors: Oliver Bocksrocker, Sachsenheim (DE); Wilrid Dubitzky, Leonberg (DE); Thomas Notheis, Schramberg (DE); Klemens Schmitt, Schramberg (DE)

(21) Appl. No.: 18/764,223

(22) Filed: Jul. 4, 2024

Related U.S. Application Data
(63) Continuation of application No. PCT/EP2022/087076, filed on Dec. 20, 2022.

(30) Foreign Application Priority Data
Jan. 5, 2022 (DE) 10 2022 100 231.4

(51) Int. Cl. B23K 26/03; B23K 26/21

(52) U.S. Cl. CPC B23K 26/032; B23K 26/21

(57) ABSTRACT

A method for laser beam welding of a plurality of component parts at a plurality of processing locations of a component by using a laser welding apparatus includes (a) measuring a respective processing location of the plurality of processing locations by using a measurement beam and/or by using a sensor system, and (b) laser beam welding of a previously measured processing location of the plurality of processing locations by using a processing beam. The steps (a) and (b) are carried out in parallel.

### CROSS REFERENCE TO RELATED APPLICATIONS

This application is a continuation of International Application No. PCT/EP2022/087076 (WO 2023/131522 A1), filed on Dec. 20, 2022, and claims benefit to German Patent Application No. DE 10 2022 100 231.4, filed on Jan. 5, 2022. The aforementioned applications are hereby incorporated by reference herein.

### FIELD

Embodiments of the present invention relate to a method for laser beam welding of a plurality of component parts at a plurality of processing locations of a component by using a laser welding apparatus, and to a laser welding apparatus.

### BACKGROUND

Various applications in which a plurality of component parts are joined at many processing locations of a component by means of laser beam welding are known. In such applications, it is known to use solid-state lasers for the laser beam welding. The component is moved beneath the respective optical unit of the solid-state laser, or alternatively the optical unit itself is moved in relation to the component, in order to cover the entire processing space of the component with all processing locations.

For accurately positioned laser beam welding, it is necessary to measure the processing locations before the actual processing, that is to say the laser beam welding, that is to say to acquire the positions of the component parts to be welded to the component at the processing locations. A sequential measurement of the processing position is carried out by means of a corresponding sensor system and the component parts are processed, that is to say laser beam welded, onto the component.

Since the measurement of the processing location, or the positions of the component parts to be welded, on the component needs to take place before the processing, or the laser beam welding, the procedure involves sequential measurement and processing. Yet since the beams used for this purpose, that is to say the measurement beam and the processing beam, have the same light path in the optical unit of the measurement beam, the known method is very time-consuming. Consequently, the joining of the component parts to the component is time-consuming.

### SUMMARY

Embodiments of the present invention provide a method for laser beam welding of a plurality of component parts at a plurality of processing locations of a component by using a laser welding apparatus. The method includes (a) measuring a respective processing location of the plurality of processing locations by using a measurement beam and/or by using a sensor system, and (b) laser beam welding of a previously measured processing location of the plurality of processing locations by using a processing beam. The steps (a) and (b) are carried out in parallel.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a plan view of a component in the form of a stator with component parts in the form of hairpins to be joined thereto according to some embodiments;

FIG. 2a shows a cross-sectional view through a laser welding apparatus according to some embodiments for joining the component parts to the component of FIG. 1;

FIG. 2b shows a plan view of the component of FIG. 1 with, imaged thereon, scan fields of the scanner optical units of the laser welding apparatus of FIG. 2a, according to some embodiments;

FIGS. 3a-3d show a sequence of plan views of the component corresponding to FIG. 2b in a method according to some embodiments;

FIG. 4a shows a cross-sectional view through a laser welding apparatus according to some embodiments for joining the component parts to the component of FIG. 1;

FIG. 4b shows a plan view of the component of FIG. 1 with, imaged thereon, scan fields of the scanner optical units of the laser welding apparatus of FIG. 4a according to some embodiments; and

FIGS. 5a-5d show a sequence of plan views of the component corresponding to FIG. 3b in a method according to some embodiments.

### DETAILED DESCRIPTION

Embodiments of the invention provide a method for the laser beam welding of a plurality of component parts at different processing locations of a component by means of a laser welding apparatus, and a corresponding laser welding apparatus, by means of which the costs for joining the component parts to the component can be reduced, and in particular the cycle time for the laser beam welding of the component parts at the different processing locations of the component can be reduced.

According to some embodiments, a method for the laser beam welding of a plurality of component parts at different processing locations of a component by means of a laser welding apparatus is proposed, the method comprising the following steps: (a) measurement of a processing location (of the plurality of processing locations) by means of a measurement beam and/or by means of a sensing unit, in particular a position- and time-resolving sensing unit, and (b) laser beam welding of a previously measured processing location (of the plurality of processing locations) by means of a processing beam, wherein steps (a) and (b), that is to say the measurement and the laser beam welding, are carried out in parallel.

Embodiments of the invention therefore provide a method by means of which parallel measurement and laser beam welding is made possible. This is provided by a parallel measurement at a processing location and laser beam welding at a processing location, which is different from the processing location at which measurement is taking place but which has already been measured previously, respectively taking place, so that accurately positioned laser beam welding or processing of the component, or joining of the respective component parts to the component by laser beam welding, is nevertheless made possible. Correspondingly, the cycle time for the laser beam welding can be reduced significantly in relation to the known sequential measurement and laser beam welding.

Parallel performance of the measurement and the laser beam welding, which is also referred to herein as processing, means in particular at least partially simultaneous performance. This means that the two steps of measuring and laser beam welding need not necessarily take place simultaneously over their entire duration, or that one of the two steps (a), (b) needs to be carried out entirely while the other is being carried out. Instead, it is sufficient even if only a certain period of time for carrying out step (a) overlaps with a certain period of time for carrying out step (b), so that in the present context this is to be regarded as parallel performance. Advantageously, however, the steps (a) and (b) should be carried out coincidently, or simultaneously, over a length of time that is as great as possible in order to reduce the cycle time of the method as much as possible. It is therefore advantageous for one of the two steps (a), (b) to be carried out (substantially) fully while the respective other step (a), (b) is being carried out.

A processing location means in particular a region on the component, which preferably comprises a plurality of component parts and on which the component parts are provided, in particular positioned. The component and the component parts to be joined thereto can therefore be divided into a plurality of processing locations, which can be processed successively. The measurement is used in particular to establish the positions of the component parts at a processing location, which may alternatively be referred to as a processing region. In other words, in particular, the positions (and possible position deviations from predefined positions) of the component parts on or in the component are acquired during the measurement of a processing location. A processing location therefore respectively comprises in particular a plurality of component parts and their positions on the component, which are not yet fixed by the welding but for instance are only provided by placement or insertion. By the measurement, it is therefore also possible to establish position deviations from a predetermined position, and these may be taken into account for the subsequent laser beam welding in order to enable accurately positioned welding. This may be ensured by a corresponding control unit, which will be explained in more detail below. The control unit may adapt the step of laser beam welding respectively to the positions of the component parts that have been acquired previously by the measurement.

A further measurement step (the first measurement step for a component) may precede the two steps (a) and (b) respectively carried out in parallel. This first measurement step may take place at the very start of the method when there is not yet a previously measured processing location at which step (b) can be carried out. Such a measurement step may to this extent be a step that initializes the subsequent parallel performance of steps (a) and (b).

Advantageously, the steps (a) and (b) carried out in parallel are repeated for further processing locations of the component. In particular, the steps (a) and (b) carried out in parallel may be repeated for substantially all of the remaining processing locations of the component. A last processing step of the laser beam welding may then be carried out not in parallel with the other step, that is to say without parallel measurement, in a similar way to the first measurement step described above, because all processing locations have then already been measured, or surveyed. The cycle time of the method may thus be substantially reduced.

Steps (a) and (b) should preferably be repeated at processing locations respectively neighbouring the processing locations measured and processed immediately before. A neighbouring processing location means in particular the processing location that lies spatially closest to, or has the shortest distance from, the previously measured or processed processing location. Such processing from one processing location to the respectively closest-lying processing location allows a simple systematic procedure and reduction of nonproductive times between the actual measurement and processing times for further reduction of the cycle times.

Advantageously, the parallel measurement and laser beam welding is made possible by the laser welding apparatus comprising two (or more) optical units and by the steps (a) and (b) carried out in parallel respectively being carried out on different processing fields of the two (or more) optical units. A processing field respectively means a field of an optical unit which enables corresponding coverage of the component with the measurement beam/sensing unit and/or the processing beam. Correspondingly, the parallel measurement with the measurement beam/sensing unit respectively takes place on a different processing field from the laser beam welding with the processing beam.

It is more advantageous for the two optical units to be configured as scanner optical units. Correspondingly, the different processing fields of the scanner optical units may also be referred to as scan fields. The embodiment of the optical units as scanner optical units, in contrast to a solid-state optical unit, allows scanner welding in which the relative movement necessary in the prior art between the component and the optical unit or the laser processing head with the optical unit in the scan field is no longer necessary, or is at least reduced. In addition to lenses, for example a collimation lens and a focusing lens, a scanner optical unit comprises one or more mirrors. Accordingly, scanner welding means a welding method in which the processing beam is guided by one or more mobile mirrors inside the scanner optical unit of the scanner welder. The processing beam is guided by the angle variations of the one or more mirrors. This creates a scan field in which welding can be carried out highly dynamically and precisely. Correspondingly, the component with the component parts can be processed entirely inside the two scan fields of the two scanner optical units. In particular, the scanner optical units may also be used for guiding the measurement beam over the scan fields, so that the measurement and the laser beam welding are possible inside the two scan fields without relative movement between the scanner optical units and the component. The cycle time can also be reduced in this way. Further, the aforementioned nonproductive times can be reduced if the mirror or mirrors in the scanner optical unit have an ultra-lightweight design, so that they can be adjusted or rotated more rapidly.

During the repetition of the steps (a) and (b) carried out in parallel, the processing fields may respectively be changed over for steps (a) and (b) in order to carry them out in parallel. In other words, the measurement and laser beam welding may respectively take place on different processing fields. This requires correspondingly alternate coupling of the measurement beam and/or sensing unit for the measurement and the processing beam for the processing into the two optical units. By this changeover of the measurement beam and/or the sensing unit and the processing beam between the optical units, a short cycle time may be achieved because the processing fields do not need to be moved between the repetitions of steps (a), (b), so long as the two processing fields contain processing locations that have not yet been measured and laser beam welded.

In principle, the laser welding apparatus may be configured with one, two or more laser beam sources. However, the use of a laser beam welding apparatus with a laser beam device having a single laser beam source, which is switched over between the two processing fields during the repetition of steps (a) and (b), is economical. In other words, the processing beam of the single laser beam source may respectively be switched to and fro between the two optical units for the repetition of steps (a) and (b). For this purpose, the laser beam source may have two outputs, in particular cables or fibres, each of which leads to one of the two optical units.

A corresponding measuring device of the laser welding apparatus may also be switched to and fro between the two optical units for the repetition of steps (a) and (b). Alternatively, however, two or more measuring devices may also be used. In particular, each of the optical units may respectively be assigned a measuring device. It is then necessary only to switch the processing beam to and fro between the optical units.

It is advantageous for the two processing fields not to overlap, or to overlap at most in an area of 50%, in particular in an area of at most 30%, of one of the two processing fields. It is thereby possible to process large processing fields that are independent as far as possible, which prevents or minimizes additional movement, for example rotation, of the component and/or optical unit(s). A slight overlap of the processing fields, set within the limits above, may however be tolerated in order to be able to cover the component fully by the two processing fields.

Advantageously, a separating device of the laser welding apparatus is arranged between the two processing fields in order to avoid mutual influencing of the measurement beam and/or the sensing unit and the processing beam. The separating device may, for example, be configured as a shutter. The separating device protects the measuring device of the measurement beam and/or of the sensing unit against back-reflections of the processing beam so that erroneous measurements are prevented, which could lead to erroneous processing and in the worst case rejection of the component.

It is further possible for the measurement beam and/or the sensing unit and the processing beam to be set up substantially coaxially with one another by each of the two optical units. In other words, the laser welding apparatus is, and in particular its at least one laser beam device and its at least one measuring device are, set up in such a way that the measurement beam and/or an acquisition field of the sensing unit and the processing beam can emerge coaxially from each of the two optical units. This does not mean that the two different beams actually run coaxially with one another simultaneously, because as described above they run, in particular, alternately and in different optical units. They do, however, preferably share the same axis during this alternation. Such a coaxial arrangement of the measurement beam and/or sensing unit and processing beam allows rapid changing between the two steps (a) and (b), i.e. the measurement and laser beam welding during the repetition of steps (a) and (b).

The component and/or the laser welding apparatus, in particular its optical units or laser processing head, may be moved after a predefined number of repetitions of steps (a) and (b). The number of repetitions may be predefined by the number of required repetitions of steps (a) and (b) in order to process all processing locations inside the two processing fields of the optical units. Thus, if there are processing locations awaiting processing only outside the processing fields, the component and/or the laser welding apparatus is moved in order to enable the further processing. The movement may, in particular, be a rotation.

More particularly, the component may in other regards be a rotationally symmetrical component. In particular, the component may be a stator. The component parts may in turn be conductor elements, in particular rod-shaped conductor elements, which are also known as hairpins. The conductor elements may, for example, have a rectangular cross section. Furthermore, the conductor elements may for example be made from copper or aluminium.

An OCT measurement beam of an OCT sensor system (as the measuring device of the laser welding apparatus) may preferably be used as the measurement beam. An OCT sensor system means an optical coherence tomography (OCT) sensor system. With the measurement beam generated by the OCT sensor system, a short measurement time and high accuracy may be achieved, which in turn has an advantageous effect on the welding accuracy and allows the cycle time to be reduced further. Alternatively or in addition, a sensing unit may however also be used. The sensing unit may be a position- and time-resolving sensing unit. For example, the sensing unit may be a camera or be formed by a plurality of cameras.

According to some embodiments, a welding apparatus for the laser beam welding of a plurality of component parts at different processing locations of a component is provided, the laser welding apparatus being configured with a laser beam device, at least one measuring device, at least one optical unit and a control unit, wherein the control unit is adapted in order, in parallel, (a) to measure a processing location of the plurality of processing locations by means of a measurement beam and/or a sensing unit of the at least one measuring device and (b) to laser beam weld a previously measured processing location by means of a processing beam.

The features described herein in respect of the method according to embodiments of the invention may of course also be applied in respect of the laser welding apparatus according to embodiments of the invention, and vice versa. In particular, the laser welding apparatus may be adapted to carry out the method according to embodiments of the invention, or the control unit may be adapted so that the respective steps of the method according to embodiments of the invention are carried out by means of the laser welding apparatus.

As mentioned above, the laser welding apparatus may comprise one, two or more laser beam sources for the laser beam device. More particularly, the laser beam device may comprise an infrared laser as the laser beam source. This laser may be adapted in particular for a brilliance ≥5 and/or a beam parameter product≤4 mm*mrad of the processing beam, or may be adapted for such a working range and may also be used therein during the method according to embodiments of the invention in order to carry out the laser beam welding. The processing time or laser beam welding time of step (b) can thereby be shortened to such an extent that it corresponds at least approximately to the measurement time of step (a), so that the cycle time of the method can be reduced further overall.

The laser welding apparatus may also comprise one or more measuring devices. Further, the laser welding apparatus may comprise two or more optical units, in particular in the form of scanner optical units. In particular, the aforementioned separating device may be arranged between the optical units. For example, scanner optical units marketed by TRUMPF under the brand name PFO 33-2, with an exemplary imaging ratio of 1.7:1, may be used as scanner optical units. The measuring devices, or respective sensor units of the measuring devices, may be integrated into the optical units. The axis of the measurement beam may coincide with the axis of the processing beam inside each of the two or more optical units, as explained above.

For example, it is possible to use a camera-based sensing unit as or in the measuring device. For example, the camera-based sensor system marketed by TRUMPF under the brand name VisionLine Detect may be used. This allows accurate determination of the position and position deviations of the individual component parts to be welded to the component. An optical filter or bandpass filter, which may in particular be transmissive in the VIS range or NIR range or parts thereof, may additionally be used. Alternatively, it is conceivable to use an interferometrically based sensor system, for example the sensor system marketed by TRUMPF under the brand name VisionLine OCT Detect. In the latter, the processing beam and the OCT measurement beam may be calibrated to one another. For the processing beam, the apparatus marketed by TRUMPF under the brand name TruLaser Cell 3000 may for example be used.

For example, it is further or alternatively possible for a laser welding apparatus marketed by TRUMPF under the brand name TruDisk Laser with a beam parameter product of for example 2 mm*mrad to be used. The laser beam source may be set up with two or more outputs so that the light paths of the laser beam source can be switched to and fro between two optical units.

For guiding the light path of the laser beam source, it is possible to use a fibre guide which, in particular, may be provided by a 2-in-1 fibre-optic cable. The 2-in-1 fibre-optic cable may be configured with an inner fibre core, or an inner fibre, and an outer fibre core, or an outer fibre, in particular a fibre that encloses the inner fibre core. The inner fibre core may for example have a diameter of up to 50 μm, whereas the ring fibre may for example have a diameter of up to 200 μm. Such a 2-in-1 fibre-optic cable may also be referred to as a multiclad fibre. In order to generate the processing beam, an initial laser beam may be launched into a first end of the multiclad fibre. A first part of the laser power of the initial laser beam may be launched into the core fibre and a second part of the laser power of the initial laser beam may be launched into the ring fibre. Lastly, a second end of the multiclad fibre may be imaged onto the component. This makes it possible to produce a smooth surface of the weld seams that are generated.

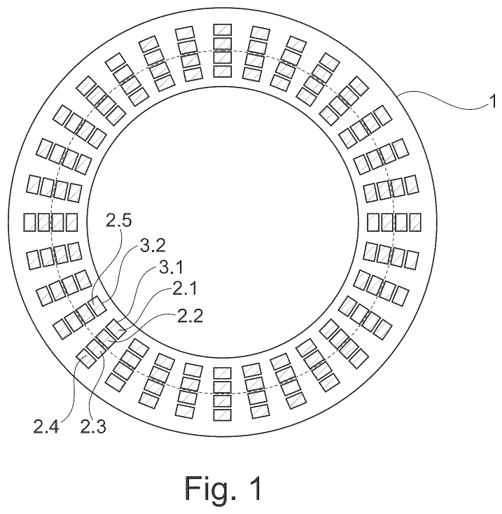

FIG. 1 shows a rotationally symmetrical component 1 in the exemplary form of a stator 1 of an electrical machine (not shown), in particular of an electric motor (not shown), on which a multiplicity of component parts in the exemplary form of rod-shaped conductor elements 2.1, 2.2, 2.3, 2.4, 2.5, only some of which are labelled, are arranged in a plurality of rows 3.1, 3.2, only two of which are labelled. The rod-shaped conductor elements 2.1, 2.2, 2.3, 2.4, 2.5, also referred to as hairpins, are intended to be joined by laser beam welding to the stator 1, i.e. welded thereon. The hairpins 2 in FIG. 1 are located in a predetermined position on the stator 1, and are for example placed or inserted there.

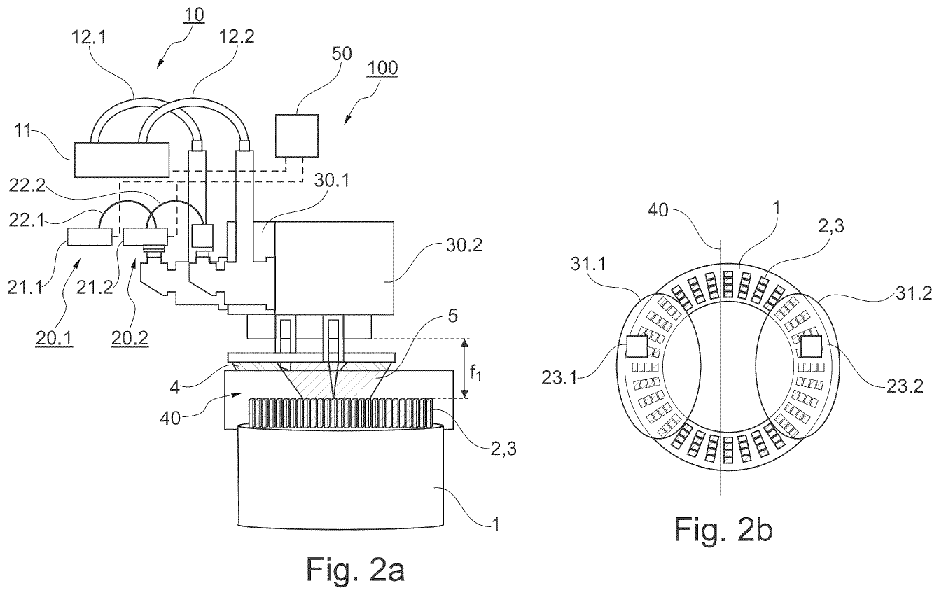

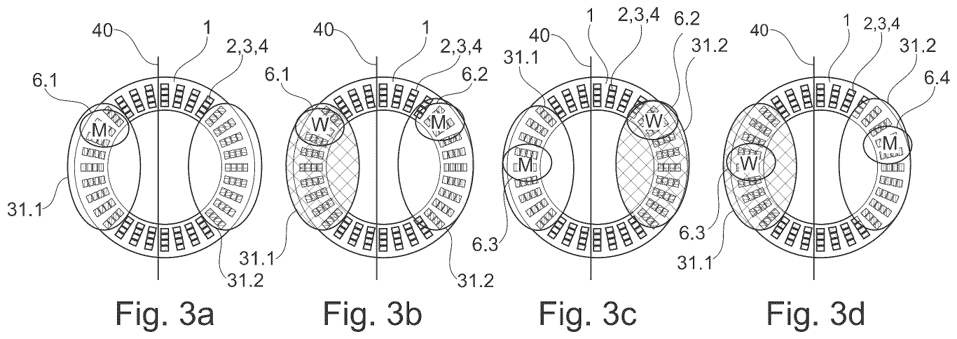

FIGS. 2a, 2b and 3a to 3d show an exemplary embodiment of a laser welding apparatus 100 when carrying out an exemplary embodiment of a method for laser beam welding of the plurality of hairpins 2.1, 2.2, 2.3, 2.4, 2.5 onto the stator 1.

The laser welding apparatus 100 of the present exemplary embodiment comprises a laser beam device 10 with by way of example a single laser beam source 11 and two 2-in-1 fibre-optic cables 12.1, 12.2 for guiding the laser beam, or processing beam 5 for the laser beam welding process, emitted by the laser beam source 11 into corresponding optical units 30.1, 30.2 of the laser welding apparatus 100. The optical units 30.1, 30.2 shown are configured as scanner optical units 30.1, 30.2 with a mirror or mirrors (not shown) contained therein, and may additionally comprise for example a collimation lens and focusing lens (not shown) for directing the processing beam 5 onto the component 1.

The two scanner optical units 30.1, 30.2 are respectively fed with a measurement beam 4 by way of example by different measuring devices 20.1, 20.2 comprising sensor systems 21.1, 21.2 and optical fibres 22.1, 22.2. Merely for the sake of clarity, the sensor systems 21.1, 21.2 are shown outside the scanner optical units 30.1, 30.2. They may, however, in particular also be arranged inside the scanner optical units 30.1, 30.2. The measuring devices 20.1, 20.2 may, for example, be configured as camera-based sensor systems or OCT sensor systems 20.1, 20.2.

The measurement beam 4 and the processing beam 5 are guided coaxially by the scanner optical units 30.1, 30.2, although the measurement beam 4 and the processing beam 5 are not intended to be guided simultaneously therein by one of the two scanner optical units 30.1, 30.2. Instead, the measurement beam 4 and the processing beam 5 are intended to be guided chronologically in parallel respectively in one of the two scanner optical units 30.1, 30.2, as will be explained in more detail below.

Between the two scanner optical units 30.1, 30.2, or scan fields 31.1, 31.2 acquired by the scanner optical units 30.1, 30.2, there is a separating device 40 in the exemplary form of a shutter, which prevents the processing beam 5 from detrimentally influencing the measurement by means of the measurement beam 4.

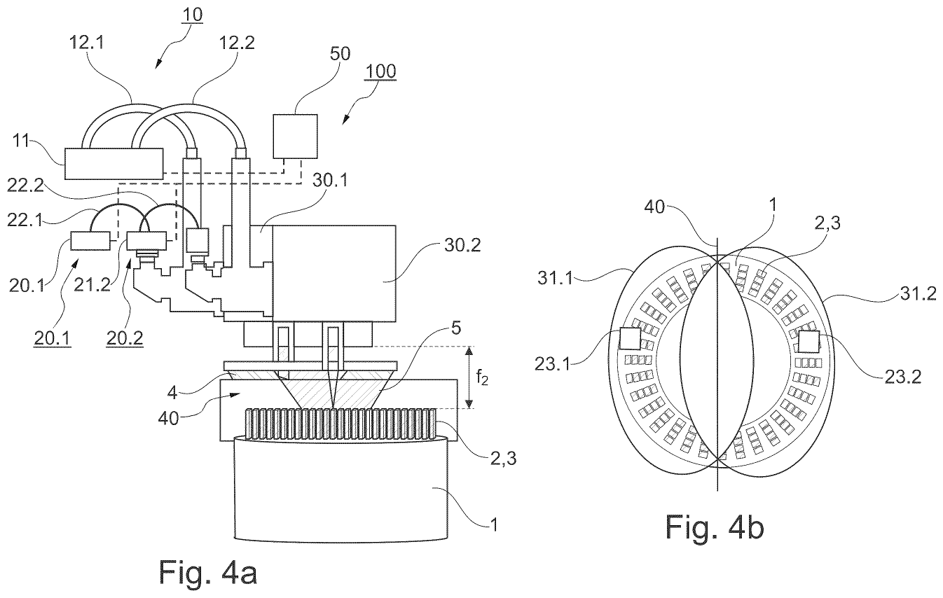

The focal length f₁ in the present exemplary embodiment is, for example, f255. The working distance for this focal length f₁ in the present case means that the scan fields 31.1, 31.2 do not overlap on the component 1 and the conductor elements 2. FIG. 2b (and FIG. 4b) in the present case also show acquisition fields 23.1, 23.2 of the sensor system used in an illustrative manner.

A control unit 50 of the laser welding apparatus 100 is connected at least to the laser beam device 10 and the measuring devices 20.1, 20.2, and is adapted to operate the laser beam welding apparatus 100 according to an exemplary embodiment of the method for joining the component parts 2 and the component 1 to one another, as will be explained in more detail below with the aid of FIGS. 3a to 3d.

At the start of the method, a measurement step labelled M takes place inside a first processing location 6.1 inside a first scan field 31.1 of the scanner unit 30.1. This is done with the aid of the measurement beam 4 of the first measuring device 20.1, which is assigned to the first scanner optical unit 30.1. The positions of the hairpins 2 on the stator 1 inside the first processing location 6.1, or this processing region, can thereby be acquired. Each one of the processing locations 6.1, 6.2, 6.3, 6.4 shown in FIGS. 3a to 3d comprises by way of example a plurality of hairpins 2, in particular rows 3 of hairpins 2, which can respectively be measured by a measurement beam 4 in order to acquire their positions and possible position deviations from predefined positions.

The acquired positions can be transmitted from the first measuring device 30.1 to the control unit 50, which can in turn process them in order to correspondingly control the laser beam device 10 and/or the scanner optical units 30.1, 30.2 for the processing operation for the laser beam welding presented below and shown in FIG. 3b, so that optimum welding and an optimum welding outcome can be ensured. As shown in this regard by FIG. 3b, the welding process labelled W (for “welding”) is now carried out by means of the processing beam 5 at the first processing location 6.1. In parallel, or simultaneously, a measurement by means of the measurement beam 4 is carried out at a second processing location 6.2. The second processing location 6.2, however, is now located in the second scan field 31.2 of the second scanner optical unit 30.2. Consequently, the second measuring device 20.2 assigned to the second scanner optical unit 30.2 is used for the measurement of the second processing location 6.2.

FIG. 3c now shows the sequence of a further repetition of a parallel measurement step M and processing step W. On the one hand, the processing step W is carried out in the second scan field 31.2 at the second processing location 6.2 measured immediately before, and on the other hand a further measurement step M is carried out in parallel therewith at a third processing location 6.3. The third processing location 6.3 is located next to the first processing location 6.1 inside the first scan field 31.1. For the measurement step M of FIG. 3c, the first measuring device 20.1 is again in use. For the processing step W, the output or fibre-optic cable 12.1, 12.2 of the laser beam source 11 is furthermore changed over so that the processing beam 5 in FIG. 3c is coupled by means of the fibre-optic cable 12.2 into the second scanner optical unit 30.2 with the second scan field 31.2, instead of as previously in FIG. 3b into the first scanner optical unit 30.1 by means of the fibre-optic cable 12.1.

This parallel procedure consisting of measuring M by means of the measurement beam 4 and processing W by means of the processing beam 5 is now continued, as shown by FIG. 3d, until all processing locations 6.1, 6.2, 6.3, 6.4, only four of which are shown by way of example in the present case, have been processed inside the scan fields 31.1, 31.2. Subsequently, the stator 1 may for example be rotated, in particular through 90°, in order to direct the scan fields 31.1, 31.2 onto an as yet unprocessed region of the stator 1, or as yet unprocessed processing locations, in order to carry out the laser beam welding further.

The parallel measurement and laser beam welding according to embodiments of the invention can achieve a significant cycle time advantage during the joining of the component parts 2 to the component 1 compared with the sequential method known from the prior art. By the use of scanner optical units 30.1, 30.2 and a laser beam source 11 with high brilliance, for example an infrared laser with P≥5, this cycle time advantage can be further enhanced.

The total time required for the processing, or joining of the hairpins 2 onto the stator 1, may be determined by the sum of the times needed for the first measurement step, for the changeover of the light path of the laser beam device 10 to one of the two scanner optical units 30.1, 30.2, for the laser beam welding by means of the processing beam 5 and for the rotation of the stator 1. Because the measurement by means of the measurement beam 4 respectively takes place during the laser beam welding, this time does not additionally need to be included in the calculation. The measurement typically takes less time than the individual welding processes. Thus, it may for example be assumed that a measurement process lasts about 120 ms, the changeover of the light path or fibre-optic cable 12.1, 12.2 of the laser beam device 10 lasts about 80 ms and the welding or processing operation lasts 200 ms. For the stator 1 shown in FIG. 1, equipped by way of example with 288 hairpins 2, this leads to a short processing duration of approximately 63 seconds in order to weld all hairpins 2 in the correct position onto the stator 1.

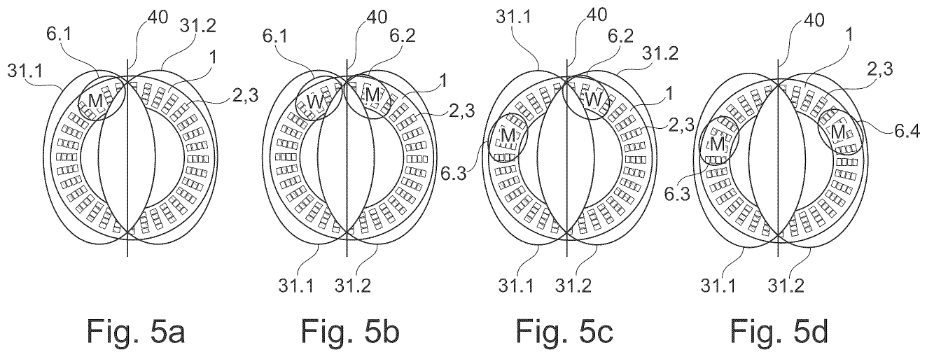

FIGS. 4a, 4b and 5a to 5d show an alternative exemplary embodiment of a laser welding apparatus 100 and a corresponding alternative exemplary embodiment of a method.

The structure of the laser welding apparatus 100 of FIG. 4a corresponds to the laser welding apparatus 100 of FIG. 2a with the exception of the focal length f₂. The focal length f₂ is greater than the focal length f₁ of FIG. 2a, and the focal length f₂ may for example be f450.

This means that the scan fields 31.1, 31.2 of the two scanner optical units 30.1, 30.2 are larger and partially overlap one another, as shown by FIG. 4b. Consequently, it is possible to process the entire stator 1 without having to rotate it during the method.

A method sequence corresponding in its representation to FIGS. 3a to 3d is shown in FIGS. 5a to 5d for a method according to FIGS. 4a and 4b. The processing time of the method of FIGS. 5a to 5d is reduced by the time needed to rotate the stator 1 in the method of FIGS. 3a to 3d, which may for example be 2 seconds.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A method for laser beam welding of a plurality of component parts at a plurality of processing locations of a component by using a laser welding apparatus, the method comprising:
(a) measuring a respective processing location of the plurality of processing locations by using a measurement beam and/or by using a sensor system, and
(b) laser beam welding of a previously measured processing location of the plurality of processing locations by using a processing beam,
wherein the steps (a) and (b) are carried out in parallel.

2. The method according to claim 1, wherein the steps (a) and (b) carried out in parallel are repeated for further processing locations of the plurality of locations of the component.

3. The method according to claim 2, wherein the steps (a) and (b) are repeated at the further processing locations neighbouring the processing locations measured and processed immediately before.

4. The method according to claim 2, wherein the laser welding apparatus comprises two optical units, and the steps (a) and (b) carried out in parallel are respectively carried out on two different processing fields of the two optical units.

5. The method according to claim 4, wherein the two optical units are configured as scanner optical units.

6. The method according to claim 4, wherein during the repetition of the steps (a) and (b) carried out in parallel, the two processing fields are respectively changed over for steps (a) and (b) in order to carry out the steps (a) and (b) in parallel.

7. The method according to claim 6, wherein a laser beam device having a single laser beam source is used, which is switched between the two processing fields during the repetition of the steps (a) and (b).

8. The method according to claim 4, wherein the two processing fields do not overlap, or overlap at most in an area of 50% of one of the two processing fields.

9. The method according to claim 4, wherein the laser welding apparatus comprises a separating device arranged between the two processing fields in order to avoid mutual influencing of the measurement beam and/or the sensor system and the processing beam.

10. The method according to claim 4, wherein the measurement beam and/or the sensor system and the processing beam are set up substantially coaxially with one another by each of the two optical units.

11. The method according to claim 2, wherein the component and/or the laser welding apparatus is moved after a predefined number of repetitions of the steps (a) and (b).

12. The method according to claim 1, wherein the component is a stator and the component parts are conductor elements for the stator.

13. The method according to claim 1, wherein an OCT measurement beam of an OCT sensor system is used as the measurement beam.

14. A laser welding apparatus for laser beam welding of a plurality of component parts at a plurality of processing locations of a component, the laser welding apparatus comprising:
a laser beam device,
at least one measuring device,
at least one optical unit, and
a control unit, wherein the control unit is configured to, in parallel, (a) measure a respective processing location of the plurality of processing locations by using a measurement beam and/or a sensor system of the at least one measuring device, and (b) laser beam weld a previously measured processing location by using a processing beam.

15. The laser welding apparatus according to claim 14, wherein the laser beam device comprises an infrared laser as a laser beam source, which is configured for a brilliance ≥5 and/or a beam parameter product≤4 mm*mrad of the processing beam.
